(19) United States
(12) Patent Application Publication
(10) Pub. No.: US 2024/0247094 A1
(43) Pub. Date: Jul. 25, 2024

(54) WATERBORNE POLYURETHANE DISPERSIONS FOR PREPARING POLYURETHANE FOAM FOR SYNTHETIC LEATHER AND SYNTHETIC LEATHER ARTICLES PREPARED WITH THE SAME

(71) Applicant: Dow Global Technologies LLC, Midland, MI (US)

(72) Inventors: Xiaolian Hu, Shanghai (CN); Chao Zhang, Shanghai (CN); Ling Zhong, Shanghai (CN); Xiangyang Tai, Shanghai (CN); Yanli Feng, Shanghai (CN)

(21) Appl. No.: 18/561,328

(22) PCT Filed: Aug. 30, 2021
(86) PCT No.: PCT/CN2021/115196

§ 371 Date: Nov. 16, 2023

(51) Int. Cl. C08G 18/10; C08G 18/42; C08G 18/48; C08G 18/76; C08G 101/00; D06N 3/00; D06N 3/14

(52) U.S. Cl. CPC C08G 18/10; C08G 18/4238; C08G 18/4812; C08G 18/4825; C08G 18/4829; C08G 18/7671; D06N 3/0047; D06N 3/0063; D06N 3/0097; D06N 3/145; D06N 3/146; D06N 3/147; C08G 2101/00; C08G 2110/0083; D06N 2203/068; D06N 2205/023; D06N 2205/045; D06N 2209/10; D06N 2209/1664; D06N 2211/103; D06N 2211/106; D06N 2213/03

(57) ABSTRACT

A waterborne polyurethane dispersion for the polyurethane foam of synthetic leather application, derived from (1) a prepolymer derived from the reaction of reactants comprising at least one aromatic isocyanate compound, an ethylene oxide-capped polyether triol, at least one polyether diol, and at least one polyester diol; (2) water; and (3) surfactant, is disclosed. The waterborne polyurethane dispersion can be used to prepare a synthetic leather product having superior wrinkle resistance, hand-feeling and peel strength. A synthetic leather article prepared with said waterborne polyurethane dispersion is also disclosed.

### FIELD OF THE INVENTION

The present disclosure relates to a waterborne polyurethane dispersion (PUD) for preparing polyurethane foam for synthetic leather applications and a laminated synthetic leather article comprising a middle polyurethane foam layer derived from the composition. The laminated synthetic leather article prepared by said dispersion exhibits superior performance properties such as wrinkle resistance, hand-feeling and peel strength.

### TECHNICAL BACKGROUND

Synthetic leather gets popular applications in people's daily life, from clothes, footwear, bag and luggage, home upholstery to seats in automobile. It provides similar performance and hand feeling to natural leather with much better cost advantage. The synthetic leather is usually comprised of a top skin layer, a middle foam layer and a bottom fabric layer, and can be fabricated by sequently applying polymer materials for the middle foam layer and top skin layer/film onto the bottom fabric layer, wherein one of the most commonly used polymer material is polyurethane. Traditional polyurethane foam were prepared by using solution of polyurethane resin(s) in volatile organic solvents such as dimethylformamide (DMF), methylethyl ketone (MEK) and toluene, and this is known as solvent-borne polyurethane. However, waterborne polyurethane dispersions (PUDs) are continuously replacing the conventional solvent-borne polyurethane applied in synthetic leather industry so as to meet the requirements raised by increasingly stricter environment regulations all around the world while achieving comparable or even better performance properties as compared with the solvent-based polyurethane. Several waterborne polyurethane dispersions (PUD's) have been reported as a green alternative polyurethane foam to solvent-borne polyurethane dispersion, and almost all of them were internally emulsified PUD system prepared by using isophorone diisocyanate (IPDI). Though this type PUDs based synthetic leather showed good performance properties such as good wrinkle resistance, good hand feeling and good peel strength, they inevitably exhibit some drawbacks. Firstly, in order to achieve high solid content and thus high foam layer performance, harmful solvents (like DMF, DMAc and acetone) still has to be used in the internally emulsified PUDs. Secondly, the expensive IPDI raw material will result in high manufacture cost and discontinuous process which will lead to undesired production efficiency & consistence among different batches. Hence there is still an urgent request for unique waterborne polyurethane dispersions which can overcome the shortcomings as stated above and meet all requirements on leather performance, environmental regulations and process stability.

After persistent exploration, we have surprisingly developed a unique PUD by using a particularly designed formulation which can solve the above said shortcomings in synthetic leather.

### SUMMARY OF THE INVENTION

The present disclosure provides a unique polyurethane dispersion (PUD) for preparing foam for synthetic leather article, and a laminated synthetic leather article prepared by using the same.

In a first aspect of the present disclosure, the present disclosure provides a waterborne polyurethane dispersion for preparing polyurethane foam for synthetic leather application, wherein the waterborne polyurethane dispersion is derived from:
(1) from 40 wt % to 60 wt %, based on the total weight of the waterborne polyurethane dispersion, of a prepolymer,
wherein the prepolymer is derived from the reaction of reactants comprising: from 20 wt % to 35 wt % of at least one aromatic isocyanate compound having at least two isocyanate groups, from 20 wt % to 45 wt % of an ethylene oxide-capped (EO-capped) polyether triol, from 1 wt % to 20 wt % of at least one polyether diol, and from 20 wt % to 40 wt % of at least one polyester diol, based on the total weight of the prepolymer;
(2) from 35 wt % to 55 wt % of water, based on the total weight of the composition; and
(3) from 0.5 wt % to 5 wt % of surfactant, based on the total weight of the composition.

In a second aspect of the present disclosure, the present disclosure provides a waterborne polyurethane dispersion based foaming formulation for preparing polyurethane foam for synthetic leather application, wherein the waterborne polyurethane dispersion based foaming formulation comprises the following indispensable components:
(1) the PUD disclosed in the first aspect of the present disclosure;
(2) a secondary surfactant used as foam stabilizer;
(3) an alkali neutralizer; and
(4) a rheological modifier

In a third aspect of the present disclosure, the present disclosure provides a synthetic leather article, comprising a top skin layer; a middle foam layer derived from the PUD of the present disclosure; and a bottom fabric layer.

It is to be understood that both the foregoing general description and the following detailed description are exemplary and explanatory only and are not restrictive of the invention, as claimed.

### BRIEF DESCRIPTION OF THE DRAWINGS

FIG. 1 is a schematic illustration of a cross-section of one embodiment of a synthetic leather laminate structure described herein.

### DETAILED DESCRIPTION OF THE INVENTION

Unless defined otherwise, all technical and scientific terms used herein have the same meaning as commonly understood by one of ordinary skill in the art to which the invention belongs. Also, all publications, patent applications, patents, and other references mentioned herein are incorporated by reference.

As disclosed herein, “and/or” means “and, or as an alternative” or “additionally or alternatively”. All ranges include endpoints unless otherwise indicated.

In an embodiment of the present disclosure, the waterborne polyurethane dispersion is derived from, i.e. obtained by combining components comprising (1) a prepolymer, (2) water and (3) surfactant, wherein the prepolymer comprises more than one isocyanate groups and is a product formed by the reaction, especially condensation reaction, of reactants comprising (a) at least one aromatic isocyanate compound having at least two isocyanate groups, (b) an ethylene oxide-capped polyether triol, (c) at least one polyether diol, and (d) at least one polyester diol.

In an embodiment of the present disclosure, the aromatic isocyanate compound is a C₆-C₁₅ aromatic isocyanate compound having at least two isocyanate groups. The C₆-C₁₅ aromatic isocyanate compound be can selected from the group consisting of diphenylmethanediisocyanate (MDI), toluene diisocyanate (TDI), naphthalene diisocyanate (NDI), phenylene diisocyanate, any isomers thereof and any combinations thereof. The isomers of MDI comprise 4,4′-MDI, 2,4′-MDI, 2,2′-MDI, etc.; the isomers of TDI comprise 2,3-TDI, 2,4-TDI, 2,5-TDI, 2,6-TDI, 3,4-TDI, 3,5-TDI, etc.; the isomers of NDI comprise 1,5-NDI, 1,2-NDI, 1,3-NDI, 1,4-NDI, 1,6-NDI, 1,7-NDI, 1,8-NDI, 2,3-NDI, 2,6-NDI, 2,7-NDI, etc; the isomers of phenylene diisocyanate comprise 1,2-phenylene diisocyanate, 1,3-phenylene diisocyanate, 1,4-phenylene diisocyanate, etc.; and the aromatic isocyanate compound may comprise any one or more of the above indicated isomers. According to an embodiment of the present disclosure, the aromatic isocyanate compound is MDI, such as a mixture of 4,4′-MDI and 2,4′-MDI, particularly speaking, a mixture of 50-99 wt % of 4,4′-MDI and 1 to 50 wt % of 2,4′-MDI, or a mixture of 98 wt % of 4,4′-MDI and 2 wt % of 2,4′-MDI.

According to an embodiment of the present disclosure, the content of the aromatic isocyanate compound can be from 20 wt % to 35 wt %, based on the total weight of the prepolymer, such as within a numerical range obtained by combining any two of the following end points: 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt % and 35 wt %.

According to an embodiment of the present disclosure, minor amount of polyisocyanate compound (which will be referred as “secondary polyisocyanate compound”) other than the above said aromatic isocyanate compound can be included as a part of the reactants for preparing the prepolymer or as a coreactant used in combination with the prepolymer, wherein the secondary polyisocyanate compound can be aliphatic or cycloaliphatic isocyanate compound having two or more isocyanate groups, such as C₄-C₁₂ aliphatic isocyanates comprising at least two isocyanate groups, C₆-C₁₅ cycloaliphatic isocyanates comprising at least two isocyanate groups, and combinations thereof. Specific exemplary secondary polyisocyanate compound includes methylenebis(cyclohexyl isocyanate) (HMDI), hexamethylene-diisocyanate (HDI), tetramethylene-diisocyanate, cyclohexane-diisocyanate, hexahydrotoluene diisocyanate, isophorone diisocyanate (IPDI), or mixtures thereof. The content of said secondary polyisocyanate compound can be up to 50 wt %, or up to 40 wt %, or up to 35 wt %, or up to 30 wt %, or up to 25 wt %, or up to 20 wt %, or up to 15 wt %, or up to 10 wt %, or up to 8 wt %, or up to 6 wt %, or up to 5 wt %, or up to 4 wt %, or up to 3 wt %, or up to 2 wt %, or up to 1 wt %, or up to 0.5 wt %, or up to 0.1 wt %, or 0 wt %, based on the total weight of all the isocyanate compounds, i.e. the combined weight of the above stated aromatic isocyanate compound and the secondary polyisocyanate compound.

According to another embodiment of the present disclosure, all the components for preparing the PUD only comprises the aromatic isocyanate compound and does not comprise the secondary polyisocyanate compound as stated above, i.e. the content of the secondary polyisocyanate compound is zero.

In the context of the present disclosure, all the compounds, components, dispersion or articles comprising the isocyanate group, such as the aromatic isocyanate compound, the prepolymer, the PUD and the polyurethane foam, can be characterized with the NCO content according to ASTM D5155. According to an embodiment of the present disclosure, the aromatic isocyanate compound has a NCO content of from 10 to 45 wt %, based on the total weight of the aromatic isocyanate compound(s), such as within a numerical range obtained by combining any two of the following end points: 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 33.5 wt %, 34 wt %, 35 wt %, 36 wt %, 37 wt %, 38 wt %, 39 wt %, 40 wt %, 41 wt %, 42 wt %, 43 wt %, 44 wt % and 45 wt %.

In the context of the present disclosure, the EO-capped polyether triol refers to a polyether glycol comprising end-capped EO moieties and having a hydroxyl functionality of larger than 2, such as from 2.5 to 3.8, or from 3.0 to 3.5, wherein the hydroxyl functionality comprises the contribution of both primary hydroxyl group and secondary hydroxyl group. According to an embodiment of the present disclosure, the polyether triol is an ethylene oxide-capped polyether triol comprising repeating units derived from comonomers of ethylene oxide (or ethylene glycol), propylene oxide (or propylene glycol) and glycerol. Additionally or alternatively, the ethylene oxide-capped polyether triol may comprise repeating units derived from other comonomers such as butylene oxide (or butylene glycol), pentylene oxide (or pentylene glycol), hexylene oxide (or hexylene glycol), heptane diol, octylene glycol, nonane diol, decane diol, dodecane diol, hexadecane diol, and the like. According to an embodiment of the present disclosure, the ethylene oxide-capped polyether triol has an EP content of 5 to 12 wt %, such as within a numerical range obtained by combining any two of the following end points: 5 wt %, 6 wt %, 7 wt %, 8 wt %, 9 wt %, 10 wt %, 11 wt % and 12 wt %; has a glycerol content (i.e. the relative content of repeating units derived from glycerol) of 1 to 5 wt %, such as within a numerical range obtained by combining any two of the following end points: 1 wt %, 1.5 wt %, 2 wt %, 2.5 wt %, 3 wt %, 3.5 wt %, 4 wt %, 4.5 wt % and 5 wt %; and basically comprises balance amount of propylene oxide. According to an embodiment of the present disclosure, the ethylene oxide-capped polyether triol has a Mw of from 1,500 to 6,000, or from 2,000 to 5,000, or from 2,500 to 4,000, or from 3,000 to 3,500, or within a numerical range obtained by combining any two of the above said end point values. According to a specific of the present disclosure, the ethylene oxide-capped polyether triol has an EP content of about 7 wt %, a glycerol content of about 3 wt %, and balance amount of PO.

According to an embodiment of the present disclosure, the content of the ethylene oxide-capped polyether triol can be from 20 wt % to 45 wt %, based on the total weight of the prepolymer, such as within a numerical range obtained by combining any two of the following end points: 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt % and 45 wt %.

Without being limited to any specific theory, such an ethylene oxide-capped polyether triol can be prepared by an ordinary technology, e.g. by firstly using glycerol as the initiating comonomer, followed with a copolymerization stage of an alkylene oxide, such as propylene oxide and/or other alkylene oxides as stated above, and finally capping the terminal ends of the polyether chain with copolymerized ethylene oxide. The specific molecular configuration and relative contents of each copolymerization units can be modified by controlling the factors such as timing for the addition of comonomers, relative amount of comonomers, reaction duration and process parameters such as temperature, pressure, catalyst, etc.

According to an embodiment of the present disclosure, the polyether diol refers to a polyether glycol having a hydroxyl functionality of about 1.5 to 2.2, such as from 1.8 to 2.1, or 2.0, wherein the hydroxyl functionality comprises the contribution of both primary hydroxyl group and secondary hydroxyl group, or the hydroxyl functionality solely comprises primary hydroxyl group. Without being limited to any specific theory, the polyether diol can be the homopolymer or copolymer of (C₃-C₂₀)alkylene oxide, such as polypropylene glycol, polybutylene glycol, polypentylene glycol, polyhexylene glycol, polyheptanediol, polyoctylene glycol, polynonane diol, decane diol, polydodecane diol, polyhexadecane diol, polytetrahydrofuran (PTMEG), co(ethylene glycol-propylene glycol), co(ethylene glycol-propylene glycol-butylene glycol), and the like. The above stated homopolymer or copolymer of (C₃-C₂₀)alkylene oxide may be optionally capped with ethylene oxide moiety.

According to an embodiment of the present disclosure, the polyether diol has a Mw of from 1,500 to 8,000, or from 1,600 to 6,000, or from 1,800 to 4,000, or from 2,000 to 3,000, or within a numerical range obtained by combining any two of the above said end point values.

According to an embodiment of the present disclosure, the content of the polyether diol can be from 1 wt % to 20 wt %, based on the total weight of the prepolymer, such as within a numerical range obtained by combining any two of the following end points: 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt % and 20 wt %.

Without being limited to any specific theory, the polymerization reaction for preparing the above stated polyether diols and triols can be conducted with proper starter molecules in the presence of catalyst(s). As stated above, the starter molecule for the polyether triol can be glycerol, and typical starter molecules for the EO-capped polyether diol include compounds having at least 2 hydroxyl groups or having two or more primary amine groups in the molecule. Suitable starter molecules for the EO-capped polyether diol are for example selected from the group comprising aniline, EDA, TDA, MDA and PMDA, more preferably from the group comprising TDA and PMDA, an most preferably TDA. When TDA is used, all isomers can be used alone or in any desired mixtures. For example, 2,4-TDA, 2,6-TDA, mixtures of 2,4-TDA and 2,6-TDA, 2,3-TDA, 3,4-TDA, mixtures of 3,4-TDA and 2,3-TDA, and also mixtures of all the above isomers can be used. By way of starter molecules having at least 2 and preferably from 2 to 8 hydroxyl groups in the molecule it is preferable to use trimethylolpropane, pentaerythritol, castor oil, sugar compounds such as, for example, glucose, sorbitol, mannitol and sucrose, polyhydric phenols, resols, such as oligomeric condensation products of phenol and formaldehyde and Mannich condensates of phenols, formaldehyde and dialkanolamines, and also melamine. Catalyst for the preparation of polyether diols and triols may include alkaline catalysts, such as potassium hydroxide, for anionic polymerization or Lewis acid catalysts, such as boron trifluoride, for cationic polymerization. Suitable polymerization catalysts may include potassium hydroxide, cesium hydroxide, boron trifluoride, or a double cyanide complex (DMC) catalyst such as zinc hexacyanocobaltate or quaternary phosphazenium compound.

According to an embodiment of the present disclosure, the polyester diol has a hydroxyl functionality of 1.8 to 2.2, such as from 1.9 to 2.1, or about 2.0, wherein the hydroxyl functionality comprises the contribution of both primary hydroxyl group and secondary hydroxyl group, or the hydroxyl functionality solely comprises primary hydroxyl group. The polyester polyol may have a Mw from 1,500 to 8,000 g/mol, or from 1,600 to 6,000 g/mol, or from 1,700 to 5,000 g/mol, or from 1,800 to 4,000 g/mol, or from 1,900 to 3,000 g/mol, or from 2,000 to 2,500 g/mol, or within a numerical range obtained by combining any two of the above indicated end points. Without being limited to any specific theory, typically the polyester polyol can be obtained by reacting polyfunctional alcohols having from 2 to 12 carbon atoms, or from 2 to 10 carbon atoms, with polyfunctional carboxylic acids having from 2 to 12 carbon atoms, or from 2 to 10 carbon atoms, or anhydrides/esters thereof. Typical polyfunctional alcohols for preparing the polyester polyol are diols, and may include ethylene glycol, diethylene glycol, triethylene glycol, polyalkylene glycols, 1,2-propanediol, 1,3-propanediol, 1,3-butanediol, 1,4-butanediol, 1,6-hexanediol, neopentyl glycol, and any combinations thereof. Typical polyfunctional carboxylic acids for preparing the first polyester polyol can be aliphatic, cycloaliphatic, araliphatic, aromatic or heterocyclic and may be substituted, for example with halogen atoms, and/or may be saturated or unsaturated. For example, the polyfunctional carboxylic acids are selected from the group consisting of adipic acid, suberic acid, azelaic acid, sebacic acid, phthalic acid, isophthalic acid, glutaric acid, tetrachlorophthalic acid, maleic acid, fumaric acid, itaconic acid, malonic acid, 2-methyl succinic acid, 3,3-diethyl glutaric acid, 2,2-dimethyl succinic acid, trimellitic acid, the anhydrides thereof, and any combinations thereof. According to an embodiment of the present disclosure, the polyester diol is the condensation polymerization product of adipic acid and hexane diol.

According to an embodiment of the present disclosure, the content of the polyester diol can be from 20 wt % to 40 wt %, based on the total weight of the prepolymer, such as within a numerical range obtained by combining any two of the following end points: 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt % and 40 wt %.

According to another embodiment of the present disclosure, the reactants for preparing the prepolymer may further comprise one or more polyether-based mono-ol or diol component for adjusting the modifying the hydrophilicity of the prepolymer, and this component will be referred as “hydrophilicity modifying component” hereafter. The hydrophilicity modifying component may comprise one or more of a second polyether diol which is identical with or different from the above stated polyether diol (as the diol) and a methoxy capped polyether diol as the mono-ol. According to an embodiment of the present disclosure, the hydrophilicity modifying component comprises a combination of the diol and the mono-ol, wherein the weight ratio between the diol and the mono-ol can be from 1:5 to 5:1, such as from 1:4 to 4:1, or from 1:3 to 3:1, or from 2:3 to 3:2.

For example, the second polyether diol can be selected from the group consisting of polyethylene glycol, polypropylene glycol, polybutylene glycol, polypentylene glycol, polyhexylene glycol, polyheptane diol, polyoctylene glycol, polynonane diol, polydecane diol, polydodecane diol, polyhexadecane diol, polytetrahydrofuran, co(ethylene glycol-propylene glycol), co(ethylene glycol-propylene glycol-butylene glycol), and mixtures thereof. According to an embodiment of the present disclosure, the second polyether diol has a hydroxyl functionality of 1.8 to 2.2, such as from 1.9 to 2.1, or about 2.0, wherein the hydroxyl functionality comprises the contribution of both primary hydroxyl group and secondary hydroxyl group, or the hydroxyl functionality solely comprises primary hydroxyl group. The second polyether diol may have a Mw from 600 to 5,000 g/mol, or from 700 to 4,000 g/mol, or from 800 to 3,000 g/mol, or from 900 to 2,000 g/mol, or from 1,000 to 1,500 g/mol, or within a numerical range obtained by combining any two of the above indicated end points.

According to an embodiment of the present disclosure, the content of the second polyether diol can be from 1 wt % to 10 wt %, based on the total weight of the prepolymer, such as within a numerical range obtained by combining any two of the following end points: 1 wt %, 2 wt %, 3 wt %, 4 wt %, 5 wt %, 6 wt %, 7 wt %, 8 wt %, 9 wt % and 10 wt %.

According to an embodiment of the present disclosure, the methoxy capped polyether diol can be selected from the group consisting of (methoxy)polyethylene glycol (MPEG), (methoxy)polypropylene glycol, (methoxy)polybutylene glycol, (methoxy)polypentylene glycol, (methoxy)polyhexylene glycol, (methoxy)polyheptane diol, (methoxy)polyoctylene glycol, (methoxy)polynonane diol, (methoxy)decane diol, (methoxy)polydodecane diol, (methoxy)polyhexadecane diol, (methoxy)polytetrahydrofuran, methoxy-capped co(ethylene glycol-propylene glycol), methoxy-capped co(ethylene glycol-propylene glycol-butylene glycol), and mixtures thereof.

According to an embodiment of the present disclosure, the methoxy capped polyether diol has a hydroxyl functionality of 0.9 to 1.2, such as from 1.0 to 1.1, or about 1.0, wherein the hydroxyl functionality comprises the contribution of both primary hydroxyl group and secondary hydroxyl group, or the hydroxyl functionality solely comprises primary hydroxyl group. The methoxy capped polyether diol may have a Mw from 1,500 to 8,000 g/mol, or from 1,600 to 6,000 g/mol, or from 1,700 to 5,000 g/mol, or from 1,800 to 4,000 g/mol, or from 1,900 to 3,000 g/mol, or from 2,000 to 2,500 g/mol, or within a numerical range obtained by combining any two of the above indicated end points.

According to an embodiment of the present disclosure, the content of the methoxy capped polyether diol can be from 1 wt % to 10 wt %, based on the total weight of the prepolymer, such as within a numerical range obtained by combining any two of the following end points: 1 wt %, 2 wt %, 3 wt %, 4 wt %, 5 wt %, 6 wt %, 7 wt %, 8 wt %, 9 wt % and 10 wt %.

According to a specific embodiment of the present disclosure, the hydrophilicity modifying component comprises a mixture of polyethylene glycol and (methoxy) polyethylene glycol with a weight ratio of 2:3 to 3:2.

According to another embodiment of the present disclosure, the reactants for preparing the prepolymer may further comprise at least one neutralizer for adjusting the pH of the reaction system of the prepolymer. The neutralizer may include organic acidic compounds, such as benzoyl chloride, polyphosphoric acid, or the mixture thereof. The content of the neutralizer can be from 0.001 wt % to 1 wt %, such as from 0.01 wt % to 0.1 wt %, or from 0.02 wt % to 0.05 wt %. In the context of the present disclosure, the content of the neutralized is calculated as “additional content” while taking the weight of the prepolymer as 100 wt %. Namely, when 0.01 wt % of the neutralizer is used, then the total weight of the reactants for preparing the prepolymer shall be 100.01 wt % rather than 100 wt %.

According to an embodiment of the present disclosure, the prepolymer is prepared by blending the polyol components (i.e. the ethylene oxide-capped polyether triol, the polyether diol, the polyester diol, and optionally the hydrophilicity modifying component) with the isocyanate components (i.e. the aromatic isocyanate compound) together, and the neutralizer can be added before, during or after the above said blending step. According to an embodiment of the present disclosure, the prepolymer comprises more than one free isocyanate groups and has an isocyanate groups contents (NCO %) of from 1 to 20 wt %, such as from 3 to 15 wt %, or larger than 4 wt %, or larger than 5 wt %, such as from about 3 wt % to 10 wt %.

The composition of the present disclosure comprises the above said prepolymer, water, surfactant and optional chain extender. According to one embodiment of the present disclosure, the prepolymer is packed, stored and transported independently from the other components (i.e. water, surfactant and optional chain extender).

According to an embodiment of the present disclosure, the prepolymer can be blended with water, surfactant and optional chain extender to form a polyurethane dispersion (PUD) comprising polyurethane particles, formed by the reaction between the prepolymer and water and optional chain extender in the presence of surfactant, dispersed within liquid medium (e.g. water).

According to an embodiment of the present disclosure, the polyurethane dispersion (PUD) is a waterborne polyurethane dispersion, i.e. hazardous and/or flammable solvents like dimethylformamide (DMF), dimethylacetamide (DMAc), N-methyl pyrrolidone (NMP), acetone, etc. are not used during the preparation of the PUD. According to another embodiment of the present disclosure, the PUD of the present disclosure is free of any hazardous and/or flammable solvent. According to another embodiment of the present disclosure, the PUD may optionally comprise green organic solvent, i.e. an organic solvent which is environmentally friendly, with a content of 0-15 wt %, or from 2 wt % to 12 wt %, or from 3 wt % to 10 wt %, based on the total weight of the PUD.

According to an embodiment, the waterborne polyurethane dispersion is an externally emulsified dispersion, i.e., the waterborne polyurethane dispersion is preferably prepared exclusively by using “external surfactant/emulsifier” and substantially comprises no “internal surfactant/emulsifier”.

The expression “externally emulsified polyurethane dispersion” as described herein refers to a polyurethane dispersion comprising limited amount of internally emulsifying ionic components and thus mainly relying on the emulsifying function of “external surfactant/emulsifier” [i.e. ionically or nonionically emulsifiers that are not covalently bonded to the backbone chain within the polyurethane particles dispersed in the liquid medium, especially via the urethane bond derived from the reaction between an isocyanate group and an isocyanate-reactive group (such as a hydroxyl group)] so as to stabilize the polyurethane dispersion.

According to one embodiment of the present disclose, the reactants for preparing the prepolymer do not comprise any ionic internal emulsifier or residual moieties of the ionic internal emulsifier covalently bonded to the urethane prepolymer chain. According to another embodiment of the present disclosure, the polyurethane chain in the prepolymer does not comprise any cationic or anionic pendant group.

The PUD prepared by using an internal surfactant/emulsifier is known as an “internally emulsified PUD”. According to the knowledge of the prior art, a typical process for preparing an internally emulsified PUD comprises the steps of reacting an monomeric isocyanate or a prepolymer of the monomeric isocyanate with polyols and cationic or anionic precursor which has at least one isocyanate-reactive groups (i.e., an ionic internal emulsifier) to form a PUD prepolymer comprising pendant cationic or anionic hydrophilic groups attached to the polyurethane chain; dispersing the PUD prepolymer into an aqueous solvent (e.g. water), with the cationic or anionic hydrophilic group attached to the polyurethane chain as main emulsifier, optionally with the assistance of minor amount of additional external emulsifier in this step; and optionally reacting the emulsion with additional chain extender to form the ionic internally emulsified polyurethane dispersion. It can be clearly seen that the externally emulsified PUD used in the present disclosure is completely different from the ionic internally emulsified PUD of the prior art both in the preparation process and the composition of the resultant polyurethane particles.

The waterborne polyurethane dispersion of the present disclosure may be prepared by using any anionic surfactant, cationic surfactant, amphoteric surfactant or non-ionic surfactant. Suitable classes of surfactant include, but are not restricted to, sulfates of ethoxylated phenols such as poly(oxy-1,2-ethanediyl)α-sulfo-@(nonylphenoxy) salt; alkali metal fatty acid salts such as alkali metal oleates and stearates; alkali metal C₁₂-C₁₆ alkyl sulfates such as alkali metal lauryl sulfates; amine C₁₂-C₁₆ alkyl sulfates such as amine lauryl sulfates, or triethanolamine lauryl sulfate; alkali metal C₁₂-C₁₆ alkylbenzene sulfonates such as branched and linear sodium dodecylbenzene sulfonates; amine C₁₂-C₁₆ alkyl benzene sulfonates such as triethanolamine dodecylbenzene sulfonate; anionic and nonionic fluorocarbon emulsifiers such as fluorinated C₄-C₁₆ alkyl esters and alkali metal C₄-C₁₆ perfluoroalkyl sulfonates; organosilicon emulsifiers such as modified polydimethylsiloxanes. Exemplary surfactant for preparing the PUD includes disodium octadecyl sulfosuccinate, sodium dodecylbenzene sulfonate, sodium stearate and ammonium stearate.

According to an embodiment of the present disclosure, the content of the surfactant is from 0.5 wt % to 5 wt %, such as within a numerical range obtained by combining any two of the following end point values: 0.5 wt %, 0.8 wt %, 1 wt %, 1.2 wt %, 1.5 wt %, 1.8 wt %, 2 wt %, 2.2 wt %, 2.5 wt %, 2.8 wt %, 2.99 wt %, 3 wt %, 3.1 wt %, 3.2 wt %, 3.5 wt %, 4 wt %, 4.2 wt %, 4.5 wt % and 5 wt %, based on the weight of the composition. According to an embodiment, the surfactant is dissolved in the water used to prepare the PUD. For example, the surfactant can be used in the form of an aqueous solution having a concentration of about 5 to 30 wt %, or from 10 to 28 wt %, or from 15 to 25 wt %, or from 20 to 23 wt %.

According to one embodiment of the present disclosure, the chain extender may be a diamine or an amine compound having another isocyanate reactive group (e.g., hydroxyl group, and the like), and can be selected from the group consisting of: an aminated polyether diol; piperazine; aminoethylethanolamine; C₂-C₁₆ aliphatic polyamine comprising at least two amine groups, e.g., ethylenediamine; C₄-C₁₅ cycloaliphatic or aromatic polyamine comprising at least two amine groups, such as cyclohexanediamine and p-xylenediamine; C₇-C₁₅ araliphatic polyamine comprising at least two amine groups; aminated C₂-C₈ alcohol, e.g., ethanolamine; and mixtures thereof. According to an embodiment, the chain extender is dissolved in the water used to prepare the PUD. For example, the chain extender can be used in the form of an aqueous solution having a concentration of about 5 to 30 wt %, or from 8 to 20 wt %, or from 10 to 15 wt %.

According to an embodiment of the present disclosure, the content of the chain extender is from 0.1 wt % to 15 wt %, such as within a numerical range obtained by combining any two of the following end point values: 0.1 wt %, 0.2 wt %, 0.3 wt %, 0.4 wt %, 0.5 wt %, 0.6 wt %, 0.7 wt %, 0.8 wt %, 0.9 wt %, 1.0 wt %, 1.2 wt %, 1.5 wt %, 1.8 wt %, 2.0 wt %, 3 wt %, 5 wt %, 6 wt %, 8 wt %, 9 wt %, 10 wt %, 11 wt %, 12 wt %, 13 wt % and 15 wt %, based on the weight of the prepolymer. It can be seen that the content of the chain extender is calculated as an additional amount while taking the total amount of the prepolymer as 100 wt %.

According to an embodiment of the present disclosure, the content of water for the composition (i.e., the content of water for preparing the PUD) is from 35 wt % to 55 wt %, such as within a numerical range obtained by combining any two of the following end point values: 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt % and 55 wt %, based on the total weight of the composition. Without being limited to any specific theory, the water may include those provided in various sources, such as the intentionally added pure water, the water contained in the aqueous solutions (e.g. the aqueous solutions of chain extender, surfactant and any other components), aqueous emulsion, and the like, and the above said content of water refers to the total amount of water provided by all of the various sources. According to an embodiment of the present disclosure, the content of water can be properly selected so that the polyurethane dispersion (PUD) of the present disclosure has a high solids loading of polyurethane particles, such as at least 45 wt %, or higher than 45 wt %, or higher than 47 wt %, or higher than 48 wt %, or higher than 49 wt %, or at least 50 wt %, or higher than 50 wt %, and at most 70 wt %, or at most 65 wt %, or at most 60 wt %, or at most 55 wt %.

According to an embodiment of the present disclosure, the waterborne polyurethane dispersion has a viscosity from at least about 10 cp to at most about 10,000 cp, such as within a range obtained by combining any two of the following end point values: 10 cp, 20 cp, 50 cp, 80 cp, 100 cp, 150 cp, 200 cp, 250 cp, 300 cp, 350 cp, 400 cp, 450 cp, 500 cp, 600 cp, 700 cp, 800 cp, 900 cp, 1000 cp, 1500 cp, 2000 cp, 2500 cp, 3000 cp, 3500 cp, 4000 cp, 4500 cp, 5000 cp, 5500 cp, 6000 cp, 6500 cp, 7000 cp, 7500 cp, 8000 cp, 8500 cp, 9000 cp, 9500 cp, 10000 cp.

According to an embodiment of the present disclosure, the PUD may be further foamed, cured and dried to produce the middle foam layer of a synthesis leather article exhibiting superior wrinkle resistance, hand-feeling and peel strength.

One or both of the composition and the PUD may optionally contain one or more additives such as color master batch, foam stabilizer, frothing surfactant, neutralizer, rheology modifier, thickening agent, defoamer, slipping agent, wetting agent, curing agent, filler (such as wood fiber, CaCO₃, SiO₂, and TiO₂), flame retardant, flowing additive, handfeel additive, antioxidant, anti-UV additive, antistatic agent, and antimicrobial agent.

For example, the color masterbatch may be added so as to impart a transparent or translucent film with a desired color. Examples of pigments dyes and/or colorants may include iron oxides, titanium oxide, carbon black and mixtures thereof. The amount of the pigment, dyes and/or colorant may be 0.1% to 15%, or 0.5-10%, or 1% to 5% by weight, based on the total weight of the waterborne polyurethane dispersion.

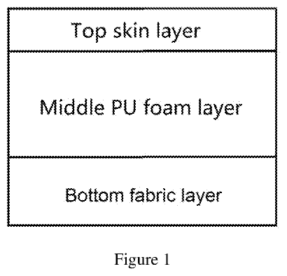

FIG. 1 is a schematic illustration of a cross-section of one embodiment of the synthetic leather article described herein. In one embodiment of the present disclosure, the synthetic leather article comprises, from top to bottom, a top skin film formed by a polyurethane material of the prior art, a middle foam layer formed by a polyurethane dispersion of the present disclosure, and a bottom fabric layer (e.g. a textile fabric cloth). Please note that the leather article is not necessarily shown in actual proportion, and the dimensions of one or more layers may be exaggerated so as to clearly show the configuration thereof.

In one embodiment of the present disclosure, the middle foam layer is formed by a frothed polyurethane foam derived from the PUD of the present disclosure and comprises a continuous polyurethane matrix defining a plurality of pores and/or cells therein. According to an embodiment of the present disclosure, the frothed polyurethane foam can be prepared by mixing the PUD of the present disclosure with one or more additives, such as second surfactant, thickener, and the like, to form a mixed substance, and frothing (e.g. by mechanically mixing and/or bubbling) the mixed substance.

The second surfactant is different from the surfactant for preparing the PUD, and may be selected from the group consisting of alkali metal fatty acid salts such as alkali metal oleates and stearates; polyoxyalkylene nonionics such as polyethylene oxide, polypropylene oxide, polybutylene oxide, and copolymers thereof; alcohol alkoxylates; ethoxylated fatty acid esters, polyglycerol fatty acid ester and alkylphenol ethoxylates; quaternary ammonium surfactants; anionic and nonionic fluorocarbon surfactants such as fluorinated alkyl esters and alkali metal perfluoroalkyl sulfonates; organosilicon surfactants such as modified polydimethylsiloxanes; alkali metal soaps of modified resins; alkyl polyglucosides; and any combinations thereof.

The thickeners may be non-associative or associative, and can be selected from the group consisting of a cellulose ether derivative, natural gum alkali swellable emulsion, a clay, an acid derivative, an acid copolymer, a urethane associate thickener (UAT), a polyether urea polyurethane (PEUPU), a polyether polyurethane (PEPU), a hydrophobically modified ethoxylated urethane (HEUR), acrylic acid copolymer-based thickener (such as ethylene acrylic acid copolymer thickener).

According to an embodiment of the present disclosure, a method for preparing a synthetic leather article comprising a top skin film, a middle foam layer formed by a polyurethane dispersion of the present disclosure, and a bottom fabric layer, is provided, wherein the method comprises the steps of: (A) reacting the reactants of 20-35 wt % of at least one aromatic isocyanate compound having at least two isocyanate groups, 20-45 wt % of an ethylene oxide-capped polyether triol, 1-20 wt % of at least one polyether diol and 20-40 wt % of at least one polyester diol, based on the total weight of the prepolymer, to form a prepolymer; (B) combining 40-60 wt % of the prepolymer with 35-55 wt % of water, 0.5-5 wt % of surfactant and optional chain extender, based on the combined weight of the prepolymer, the water and the surfactant, to form a PUD; (C) frothing the PUD to form a foamed PUD; and (D) laminating a layer of the foamed PUD with the skin layer and the bottom fabric layer to form the synthetic leather article.

According to an embodiment of the present disclosure, the synthetic leather article can be formed by applying the polyurethane skin layer, the middle foam layer and the bottom fabric layer onto a release layer in sequence. Suitable release layers are typically known in the prior art as “release paper”. Examples of suitable release layers include foils of metal, plastic or paper. In one exemplary embodiment of the present disclosure, the release layer is a paper layer optionally coated with a plastic membrane. For example, the paper layer can be coated with a polyolefin membrane, such as a polypropylene membrane. Alternatively, the paper layer can be coated with silicone. In an alternative embodiment, the release layer used herein is a PET layer optionally coated with plastic membrane. Examples of suitable release layers are commercially available. The release layers used in the present disclosure may have a flat, embossed or patterned surface so that corresponding or complementary surface profile can be formed on the outermost surface of the synthetic leather article. The release layer can be textured in the mode of leather grain so as to impart the synthetic leather article with good haptic property comparable with that of high grade natural leather. The release layer may have a thickness of 0.001 mm to 10 mm, or from 0.01 mm to 5 mm, or from 0.1 mm to 2 mm. The material and the thickness of the release layer can be properly adjusted, as long as the release layer is able to endure the chemical reaction, mechanical processing and thermal treatments experienced during the manufacturing procedures and can be readily peeled from the resultant synthetic leather without bringing about the delamination between the skin film and the middle foam layer.

In an embodiment of the present disclosure, the bottom fabric layer has a thickness of in the range from 0.01 mm to 50 mm, or in the range from 0.05 mm to 10 mm, or in the range from 0.1 mm to 5 mm. The bottom fabric layer may comprise one or more selected from the group consisting of fabric, such as woven or nonwoven fabric, impregnated fabrics, knit fabric, braid fabric or microfiber; foil of metal or plastic, e.g. rubber, PVC, polyamides, polyesters, acrylics, polyolefins, polyvinylidene chlorides or polyvinyl alcohols; leather, such as split leather; cotton, wool and hemp.

The PUD of the present disclosure, the top skin film and the bottom fabric layer may be applied by conventional coating technologies such as spraying coating, blade coating, die coating, cast coating, etc.

For example, the skin film can be prepared by blending commercialized PUD (which is completely different from the PUD of the present disclosure) with proper additives such as color masterbatch, crosslinker, thickener, slipping agent and defoamer, and then applying the blend to the releasing paper. The skin film can be either partially or completely dried before the application of the next layer. For example, the skin film is completely dried so as to minimize the moisture entrapped therein, and then the next layer (the middle foam layer) is applied thereon. In an alternative embodiment of the present application, only part of the moisture is removed from the skin film before the coating of the middle layer, then the skin film is completely dried together with the foam layer applied thereon.

According to one embodiment, the middle foam layer may be formed by blending the PUD of the present disclosure with one or more processing aiding agents selected from the group consisting of surfactant, emulsifier, thickening agent, foaming agent, catalyst, dispersing agent, dispersing aid, foam stabilizer and filler under mechanical stirring, applying the blend onto the skin film, and heating the wet foam layer in an oven at a temperature of e.g. from 70° C. to 150° C., or from 90° C. to 130° C., such as 100-110° C. for a short duration of 10 seconds to 20 minutes, or from 30 seconds to 15 minutes, or from 1 to 10 minutes. The coating of foam layer can be repeated for one, two or more times by using identical or different formulation, concentration and viscosity of the PUD to achieve desired thickness. Then the bottom fabric layer is applied to the foam layer with the assistance of a pressing roller, followed by being post cured at a temperature of e.g. from 100° C. to 160° C., or from 110° C. to 150° C. for a duration of 3 to 20 minutes, such as from 3 to 15 minutes, or from 4 to 10 minutes. The above stated two-step curing process aims to ensure high adhesion strength between the pre-cured foam layer and the fabric layer.

According to an embodiment of the present disclosure, the release layer is removed after the foam layer and the skin layer has been fully cured. The release layer can be peeled off via any ordinary technologies.

According to an embodiment of the present disclosure, after the removal of the release layer, a top finishing layer can be applied onto the surface of the synthetic leather (i.e. on the outermost surface of the skin film) and dried to form a protection film layer. The presence of the finishing layer can further increase abrasion resistance of the multilayer synthetic leather. The protection film layer may be formed by using any suitable raw materials and technologies. The finishing layer may optionally comprise additives such as wetting agent, crosslinking agent, binder, matting agent, hand-feel modifier, pigments and/or colorants, thickener or other additives used for the skin film. The synthetic leather disclosed herein can further comprise one or more than one optional additional layer such as a color layer between the skin film and the finishing layer. Other suitable optional additional layers can be selected from a water repellent layer, UV protective layer and tactile (touch/feel) modification layer. The manufacture process may be carried out continuously or batchwise. The multilayer structure synthetic leather disclosed herein can be cut or otherwise shaped so as to have a shape suitable for any desired purpose, such as shoe manufacturing. Depending on the intended application, the synthetic leathers can be further treated or post-treated similarly to natural leathers, for example by brushing, filling, milling or ironing. If desired, the synthetic leathers may (like natural leather) be finished with the customary finishing compositions. This provides further possibilities for controlling their character. The multilayer structure disclosed herein may be used in various applications particularly suitable for use as synthetic leather, for example, footwear, handbags, belts, purses, garments, furniture upholstery, automotive upholstery, and gloves.

### EXAMPLES

Some embodiments of the invention will now be described in the following examples, wherein all parts and percentages are by weight unless otherwise specified.

The information of the raw materials used in the examples is listed in the following table 1:

TABLE 1
Raw materials used in the examples

| Raw Material | Description | Vendor |
|---|---|---|
| ISONATE ™ 125M | A MDI-based mixture including on average 98 wt % 4,4′- | The Dow Chemical Company |
| | diphenylmethane diisocyanate and 2 wt % of 2,4′- | |
| | diphenylemethane diisocyanate and having an average NCO | |
| | content of 33.5 wt % | |
| IPDI | Isophorone diisocyanate, aliphatic isocyanate, functionality = 2 | BASF |
| VORANOL ™ 222-056 | An EO capped polyether diol having a Mw of 2000, an EO content | The Dow Chemical Company |
| | of 12 wt. % and a hydroxyl functionality of 2 | |
| VORANOL ™ 3010 | An EO capped polyether triol having a Mw of 3000, an EO content | The Dow Chemical Company |
| | of 7 wt %, a glycerol content of about 3 wt %, and a hydroxyl | |
| | functionality of 3 | |
| SONGSTAR SS-208 | A polyester diol, poly(hexanediol adipate) diol having a Mw of | Songwon |
| | 2000 and a hydroxyl functionality of 2 | |
| VORANOL ™ 4000-LM | A polyether diol having a Mw of 4000 and a hydroxyl functionality | The Dow Chemical Company |
| | of 2 | |
| MPEG2000 | A methoxy polyethylene glycol having a Mw of 2000 and a | Haianshihua |
| | hydroxyl functionality of 1 | |
| CARBOWAX ™ 1000 | A polyethylene glycol having a Mw of 1000 and a hydroxyl | The Dow Chemical Company |
| | functionality of 2 | |
| Water | Medium | —— |
| Benzoyl chloride | Acidic neutralizer | Sinopharm. |
| RHODACAL DS-4 | Surfactant for the foam layer, 23 wt % aqueous solution | Solvay |
| AEEA | Aminoethyethanolamine, chain extender | Sinopharm. |
| DABCO MB20 | Bismuth carboxylate catalyst | Newtop Chemical Materials |
| Black 525 | Black color master batch | Jinju Leather |
| ACRYSOL ™ RM-998 | Thickener for the skin layer | The Dow Chemical Company |
| DOWSIL ™ 8590 | Silicone based defoamer for the skin layer | The Dow Chemical Company |
| DOWSIL ™ 210S | Silicone based slipping agent for the skin layer | The Dow Chemical Company |
| Trimethylolpropane tris(2- | Aziridine crosslinker for the skin layer | Jinju Leather |
| methyl-1-aziridinepropionate) | | |
| Siwo PUE-1401 | PUD for the skin layer | SiwoChem |
| TRITON ™ CG600 | Surfactant for PUD frothing of the foam layer | The Dow Chemical Company |
| ORTEGOL EP-P 112 | Surfactant for PUD frothing of the foam layer | Evonik |
| ACRYSOL ™ 830 | Thickener for foam layer | The Dow Chemical Company |
| Siwo FB-12 | Post curing agent, water soluble blocked isocyanate | SiwoChem |
| KOH (5%) | 5% KOH aqueous solution | Sinopharm. |

### Examples 1-6 and Comparative Examples 1-5

In the following Inventive Examples (IE) 1-6 and Comparative Examples (CE) 1-5, prepolymer and PUD's for the middle foam layer were prepared by the following general procedures.

### A. The Preparation of Prepolymer

The polyether polyols and SONGSTAR SS-208 were charged into a 500 ml three neck flask equipped with heating hath, thermocouple, addition funnel and agitator, and dehydrated at 115° C. under 76 mmHg pressure for one hour, then naturally cooled down to 60° C. Benzoyl chloride (when used) was added into the dehydrated polyol mixture under nitrogen (N₂) flow protection and mechanical stirring. After 10 minutes, melt isocyanate compounds (MDI or IPDI) and catalyst (when used) were poured into the polyol mixture, and the reaction lasted at about 75° C. for 2.5 hours. The product (prepolymer) was packaged in a plastic bottle and stored hermetically under nitrogen protection for the further application.

### B. The Preparation of PUD

The prepolymer (100 g) prepared in step A was heated to 50° C. and poured into a 1000 ml plastic cup stirred with a Cowles mixer. A 23 wt % aqueous solution of RHODACAL DS-4 (13 g) was added into the plastic cup under a mixing of about 1000 rpm. The mixture within the plastic cup was stirred for 1 minute, then 20 g ice water was added therein under a stirring rate of about 2000 rpm, and then the mixture was further stirred 2 minutes. It could be seen that phase reversion occurred after the addition of water, and an oil-in-water emulsion was formed. The mixing speed was then lowered down to about 1000 rpm and the remaining ice water was added in the emulsion. After 1 minute stirring, an aqueous solution of 10 wt % AEEA was added into the emulsion and further stirred for 2 minutes. The emulsion was degassed overnight to produce a polyurethane dispersion which was stored in a plastic container with cover. The solid content of the PUDs was 50 wt %.

TABLE 2
Formulation for the prepolymer and PUD of Inventive Examples (IE) 1-6 and Comparative Examples (CE) 1-5 (in phr)

| | | | | | | | | | | |
|---|---|---|---|---|---|---|---|---|---|---|
| CE1 | CE2 | CE3 | CE4 | CE5 | IE1 | IE2 | IE3 | IE4 | IE5 | IE6 |

Prepolymer

| | | | | | | | | | | | |
|---|---|---|---|---|---|---|---|---|---|---|---|
| VORANOL ™ 222-056 | 44 | 27 | 21 | 20 | 20 | 16 | 11 | 5 | 16 | 11 | 6 |
| VORANOl ™ 3010 | 0 | 15 | 15 | 10 | 20 | 25 | 30 | 35 | 20 | 25 | 30 |
| VORANOL ™ 4000-LM | 0 | 0 | 0 | 42 | 32 | 0 | 0 | 0 | 0 | 0 | 0 |
| SONGSTAR SS-208 | 30 | 30 | 34 | 0 | 0 | 30 | 30 | 30 | 34 | 34 | 34 |
| MPEG2000 | 2 | 2 | 2 | 0 | 0 | 2 | 2 | 2 | 2 | 2 | 2 |
| PEG1000 | 0 | 2 | 2 | 2 | 2 | 3 | 3 | 3 | 2 | 2 | 2 |
| Benzoyl chloride | 0.02 | 0.02 | 0.02 | 0 | 0 | 0.02 | 0.02 | 0.02 | 0.02 | 0.02 | 0.02 |
| MDI | 24 | 24 | 26 | 0 | 0 | 24 | 24 | 24 | 26 | 26 | 26 |
| IPDI | 0 | 0 | 0 | 26 | 26 | 0 | 0 | 0 | 0 | 0 | 0 |
| DABCO MB20 | 0 | 0 | 0 | 0.1 | 0.1 | 0 | 0 | 0 | 0 | 0 | 0 |
| Total | 100.02 | 100.02 | 100.02 | 100.1 | 100.1 | 100.02 | 100.02 | 100.02 | 100.02 | 100.02 | 100.02 |
| Percentage by weight of | 0% | 20% | 20% | 13.5% | 27% | 33% | 39% | 46% | 27% | 34% | 41% |
| the VORANOL ™ 3010* | | | | | | | | | | | |

PUD

| | | | | | | | | | | | |
|---|---|---|---|---|---|---|---|---|---|---|---|
| Prepolymer | 100 | 100 | 100 | 100 | 100 | 100 | 100 | 100 | 100 | 100 | 100 |
| RHODACAL DS-4 | 13 | 13 | 13 | 13 | 13 | 13 | 13 | 13 | 13 | 13 | 13 |
| Ice water | 83.4 | 83.4 | 81.8 | 55.9 | 55.9 | 83.4 | 83.4 | 83.4 | 81.8 | 81.8 | 81.8 |
| AEEA (10% aq.) | 12 | 12 | 14 | 46.4 | 46.4 | 12 | 12 | 12 | 14 | 14 | 14 |

*Note:
the content (by weight %) of VORANOL ™ 3010 based on the combined weight of all the polyol components.

### C. The Preparation of Polyurethane Film

In this example, polyurethane films were prepared by using the PUD's synthesized in the above inventive examples and comparative examples for characterization of performance 10 properties.

In particular, 22.5 gram of the PUD prepared in each of the above said Inventive Examples 1-6 and Comparative Examples 1-5 was separately weighed and diluted with equal amount of deionized water. The diluted PUD was transferred into a vacuum oven and degassed for about 10 minutes. Then the degassed PUD was poured into a plastic surface petri dish. The dish filled with PUD was transferred into an oven and heated at 54° C. for 24 hours, after which the film was peeled from the dish, reversed and continuously dried for another 24 hours. The film was further dried under 120° C. for 30 minutes and cooled down to room temperature for testing.

### D. The Preparation of Synthetic Leather Articles

In this example, synthetic leather articles were prepared by using the PUDs synthesized in the above inventive examples and comparative examples for characterization of performance properties.

The PUD for the skin layer (Siwo PUE-1401) was mixed with color master batch, thickener, crosslinker, defoamer and slipping agent as shown in table 3 at high speed (3000 rpm) for several minutes. The formulated PUD was coated on a release paper to a wet film thickness of 100 μm. The coated release paper was dried in oven at 90° C. for 2 min and then at 110° C. for 8 min. The release paper with dried polyurethane skin layer was taken out of the oven and cooled down to ambient temperature.

TABLE 3
Formulation of the PUD for the skin layer
of the synthetic leather article

| Material | Dosage (phr) |
|---|---|
| Siwo ™ PUE-1401 | 100 |
| Black 525 | 5 |
| ACRYSOLTM RM-998 | 0.2 |
| Trimethylolpropane tris(2-methyl-1-aziridinepropionate) | 0.8 |
| DOWSIL ™ 8590 | 0.1 |
| DOWSIL ™ 210S | 4 |
| Total | 110.1 |

The PUD prepared in each of the above said Inventive Examples 1-6 and Comparative Examples 1-5 was separately mixed with frothing surfactants, post curing agent and alkali aqueous solution (see Table 4). The mixture was mechanically stirred by a Cowles mixer under a stirring rate of about 3000 rpm for several minutes until a foaming ratio of 250% was achieved, then the stirring speed was decreased to 1000 rpm and the thickener as shown in Table 4 was added to build up a high viscosity of about 20000 cp.

TABLE 4
Formulation of the PUD for the foam layer
of the synthetic leather article

| Material | Dosage (phr) |
|---|---|
| PUD | 100 |
| TRITON CG600 | 2.5 |
| ORTEGOL EP-P 112 | 4 |
| ACRYSOL 830 | 1 |
| KOH (5 wt %) | 2 |
| Siwo FB-12 | 2.5 |
| Total | 112 |

The above said foamed PUD was coated on the dried polyurethane skin film to a wet film thickness of 400 μm. The release paper with the polyurethane skin film and the coated foam layer was transferred into a 130° C. oven and pre-cured for 10 min. The polyurethane foam layer was then coated again on the coated release paper with the same scraper, carefully place a fabric cloth onto the wet foam layer and pressed with a 0.5 kg roller for 2 times. The leather specimen was put into a 130° C. oven and post-cured for 10 min and then taken out and cooled down.

### Technologies for Characterizing the Products

### (a) Mechanical Properties of the PUD Film

The modulus at 100% elongation, tensile strength and elongation at break of the PUD films obtained in Example 7 were characterized according to the standard ASTM D412-15a. For the foam layer in garment leather application, the modulus at 100% elongation is preferred to be 3.0 MPa or less for good hand-feeling.

### (b) Wrinkle Resistance Test of Synthetic Leather Article

The wrinkle resistance of synthetic leather was tested according to a method customized based on the standard ISO-105212. In particular, a 100 mm×50 mm synthetic leather sample was double folded to 50 mm×25 mm with skin layer faced together and treated in an oven at conditions of 70° C. and 95% relative humidity under 5 kg pressure for 2 hours. The leather sample was then unfolded and recovered by steam iron for 5 minutes. The wrinkle resistance was judged according to the residue of horizontal and vertical wrinkles. The rank of 4 or larger is required for garment leather application.
Rank 1: Very obvious and deep horizontal and vertical wrinkles;
Rank 2: Obvious horizontal and vertical wrinkles;
Rank 3: Some horizontal and vertical wrinkles;
Rank 4: Little horizontal and vertical wrinkles;
Rank 5: No horizontal and vertical wrinkles.

### (c) Softness or Hand-Feeling Test of Synthetic Leather

The result (Pass or Failed) was judged according to experienced leather expert's tactile sensation.

### (d) Peel Strength Test of Synthetic Leather

Leather specimen was cut into a size of 10 cm×3 cm and two skin surfaces of the specimen were pasted together with a hot melt adhesive tape (12 cm×3 cm size). The specimen was pressed by electrical iron under 150° C. for 2 minutes, one end of the leather specimen was torn by hand, and then the specimen was subject to the T-peel test under 250 mm/min crosshead speed using a 5940 Series Single Column Table Top System available from Instron Corporation. The force for peeling the two surfaces apart was recorded, and the test was repeated for three times, and the average peel force was calculated.

The performance properties of the polyurethane films and synthetic leather articles prepared by using the PUD of all the inventive examples (IE) and comparative examples (CE) were summarized in Table 5.

Table 5: performance properties of the polyurethane films and synthetic leather articles

| | | | | | | | | | | | | |
|---|---|---|---|---|---|---|---|---|---|---|---|---|
| | Performance | | | | | | | | | | | |
| Tested Property | Criteria | CE1 | CE2 | CE3 | CE4 | CE5 | IE1 | IE2 | IE3 | IE4 | IE5 | IE6 |

PUD properties

| | | | | | | | | | | | | |
|---|---|---|---|---|---|---|---|---|---|---|---|---|
| Solid content | NA | 50% | 50% | 50% | 50% | 50% | 50% | 50% | 50% | 50% | 50% | 50% |
| Modulus at 100% | NA | 1.6 | 1.8 | 2.2 | 4.2 | 4.4 | 1.9 | 2.0 | 2.2 | 2.4 | 2.6 | 2.7 |
| elongation (MPa) | | | | | | | | | | | | |
| Tensile Strength (Mpa) | NA | 13.4 | 19.8 | 32.2 | 24.9 | 19.8 | 21.1 | 18.2 | 13.9 | 29.8 | 28.3 | 26.2 |
| Elongation (%) | NA | 1017 | 875 | 650 | 801 | 700 | 750 | 672 | 578 | 620 | 601 | 583 |

Leather properties

| | | | | | | | | | | | | |
|---|---|---|---|---|---|---|---|---|---|---|---|---|
| Wrinkle resistance | ≥4 | 2 | 3 | 3 | 1 | 1 | 4 | 5 | 5 | 4 | 5 | 5 |
| Softness or hand-feeling | Pass | Pass | Pass | Pass | Failed | Failed | Pass | Pass | Pass | Pass | Pass | Pass |
| Peel strength (N/3 cm) | ≥7.5 | 14.2 | 13.8 | 15.5 | nd | nd | 13.5 | 13.3 | 12.0 | 15.0 | 14.8 | 14.5 |

The comparison between inventive examples 1-6 and comparative examples 1-3 shows that the wrinkle resistance cannot achieve a desired level until the dosage of polyether triol increases to scope defined by the present disclosure. All the inventive examples achieve low modulus at 100% elongation, which is the sigh of good softness or hand-feeling of the PUD based synthetic leather article. Besides, all the inventive examples can achieve superior peel strength.

The Comparative Examples 4-5, which were conducted by using aliphatic isocyanate compounds (IPDI), were unable to achieve desired wrinkle resistance and soft hand-feeling.

We also tried to conduct an experiment having a VORANOL 3010 content of 50 phr (based on the weight of the prepolymer), but the PUD prepared in such an experiment exhibited unacceptable stability after degassing and aging.

In summary, the particularly defined externally emulsified PUD comprising the combination of polyether triol, polyether diol, polyester diol and aromatic isocyanate compound can achieve superior wrinkle resistance, hand feeling and peel strength, while none of the comparative examples, which do not comprise the above said combination or have a composition out of the defined scope of the present disclosure, can achieve all of the superior performance properties.

1. A waterborne polyurethane dispersion for preparing polyurethane foam for synthetic leather, wherein the waterborne polyurethane dispersion is derived from:
(1) from 40 wt % to 60 wt %, based on the total weight of the waterborne polyurethane dispersion, of a prepolymer,
wherein the prepolymer is derived from the reaction of reactants comprising: from 20 wt % to 35 wt % of at least one aromatic isocyanate compound having at least two isocyanate groups, from 20 wt % to 45 wt % of an ethylene oxide-capped polyether triol, from 1 wt % to 20 wt % of at least one polyether diol, and from 20 wt % to 40 wt % of at least one polyester diol, based on the total weight of the prepolymer;
(2) from 35 wt % to 55 wt % of water, based on the total weight of the waterborne polyurethane dispersion; and
(3) from 0.5 wt % to 5 wt % of surfactant, based on the total weight of the waterborne polyurethane dispersion.

2. The waterborne polyurethane dispersion according to claim 1, wherein the is selected from the group consisting of aromatic isocyanate compound diphenylmethanediisocyanate (MDI), toluene diisocyanate (TDI), naphthalene diisocyanate (NDI), phenylene diisocyanate, and any combinations thereof.

3. The waterborne polyurethane dispersion according to claim 1, wherein the ethylene oxide-capped polyether triol is an ethylene oxide capped-propylene oxide-glycerol polyether triol having an EO content of 5 to 12 wt %, a glycerol content of 1 to 5 wt %, and a Mw of 1,500 to 6,000.

4. The waterborne polyurethane dispersion according to claim 1, wherein the polyether diol is selected from the group consisting of polypropylene glycol, polybutylene glycol, polypentylene glycol, polyhexylene glycol, polyheptane diol, polyoctylene glycol, polynonane diol, polydecane diol, polydodecane diol, polyhexadecane diol, polytetrahydrofuran, co(ethylene glycol-propylene glycol), co(ethylene glycol-propylene glycol-butylene glycol), ethylene oxide-capped derivatives thereof and mixtures thereof.

5. The waterborne polyurethane dispersion according to claim 1, wherein the polyester diol comprises condensation polymerization products of diols, selected from the group consisting of ethylene glycol, diethylene glycol, triethylene glycol, 1,2-propanediol, 1,3-propanediol, 1,3-butanediol, 1,4-butanediol, 1,6-hexanediol, neopentyl glycol, and any combinations thereof, with
polyfunctional carboxylic acids, selected from the group consisting of adipic acid, suberic acid, azelaic acid, sebacic acid, phthalic acid, isophthalic acid, glutaric acid, tetrachlorophthalic acid, maleic acid, fumaric acid, itaconic acid, malonic acid, 2-methyl succinic acid, 3,3-diethyl glutaric acid, 2,2-dimethyl succinic acid, trimellitic acid, the anhydrides thereof, and any combinations thereof.

6. The waterborne polyurethane dispersion according to claim 1, wherein the polyether diol has a Mw of 1,500 to 8,000; and
the polyester diol has a Mw of 1,500 to 8,000.

7. The waterborne polyurethane dispersion according to claim 1, wherein the reactants further comprises from 1 wt % to 10 wt %, based on the weight of the prepolymer, of a hydrophilicity modifying component selected from the group consisting of polyethylene glycol, (methoxy)polyethylene glycol, and a combination thereof.

8. The waterborne polyurethane dispersion according to claim 7, wherein the polyethylene glycol has a Mw of 600 to 5,000, and
the (methoxy)polyethylene glycol has a Mw of 1,500 to 8,000.

9. The waterborne polyurethane dispersion according to claim 1, wherein the waterborne polyurethane dispersion further comprises a chain extender and one or more optional additives selected from the group consisting of foam stabilizer, frothing surfactant, alkali neutralizer, rheological modifier, color master batch, thickening agent, defoamer, slipping agent, wetting agent and curing agent.

10. A synthetic leather article, comprising:
a top skin layer;
a middle foam layer derived from the waterborne polyurethane dispersion according to claim 1;
and a bottom fabric layer.
